(19) United States
(12) Patent Application Publication
(10) Pub. No.: US 2024/0089153 A1
(43) Pub. Date: Mar. 14, 2024

(54) ISOLATOR WITH LOW POWER STATE

(71) Applicant: Analog Devices, Inc., Wilmington, MA (US)

(72) Inventors: Jason J. Ziomek, Wilmington, MA (US); Eric C. Gaalaas, Wilmington, MA (US)

(73) Assignee: Analog Devices, Inc., Wilmington, MA (US)

(21) Appl. No.: 18/513,003

(22) Filed: Nov. 17, 2023

Related U.S. Application Data
(63) Continuation of application No. PCT/US2022/031300, filed on May 27, 2022.
(60) Provisional application No. 63/194,802, filed on May 28, 2021.

(51) Int. Cl. H04L 25/02; G06F 1/26; G06F 1/3203

(52) U.S. Cl. CPC H04L 25/0266; G06F 1/266; G06F 1/3203; G06F 2213/0042

(57) ABSTRACT

Digital isolators operable in multiple power modes are described. The digital isolators include a low power mode, in which some circuitry of the isolator operates in a lower power state than in other mode(s) of operation or may be deactivated, and in which data communication across the isolator is not permitted. The isolator may wake from the low power mode in response to a detected event or may periodically wake. Circuitry on one side of the isolator may dictate when and how the isolator wakes from a lower power mode.

### CROSS-REFERENCE TO RELATED APPLICATIONS

This application is a Continuation of International Patent Application Serial No. PCT/US2022/031300, filed May 27, 2022, under Attorney Docket No. G0766.70342W000, and entitled “ISOLATOR WITH LOW POWER STATE,” which is hereby incorporated herein by reference in its entirety.

International Patent Application Serial No. PCT/US2022/031300 claims the benefit under 35 U.S.C. § 119(e) of U.S. Provisional Patent Application Ser. No. 63/194,802, filed May 28, 2021, under Attorney Docket No. G0766.70342US00, and entitled “ISOLATOR WITH LOW POWER STATE” which is hereby incorporated herein by reference in its entirety.

### FIELD OF THE DISCLOSURE

Aspects of the present application relate generally to a digital isolator having multiple power modes, and associated circuitry and methods.

### BACKGROUND

A galvanic isolator provides galvanic isolation between two voltage domains, while allowing for communication between the two domains. Some digital isolators are Universal Serial Bus (USB) isolators, capable of isolating communications conforming to the USB protocol.

### BRIEF SUMMARY

Digital isolators operable in multiple power modes are described. The digital isolators include a low power mode, in which some circuitry of the isolator operates in a lower power state than in other mode(s) of operation or may be deactivated, and in which data communication across the isolator is not permitted. The isolator may wake from the low power mode in response to a detected event or may periodically wake. Circuitry on one side of the isolator may dictate when and how the isolator wakes from a lower power mode.

According to an aspect of the present application, a method is provided of operating a digital isolator having an isolation barrier, an isolated data channel and an isolated configuration channel. The method comprises: operating the digital isolator in a first mode in which data is communicated across the isolation barrier on the data channel and configuration information is communicated across the isolation barrier on the configuration channel; and operating the digital isolator in a second mode in which the data channel is inactive.

According to an aspect of the present application, a multi-mode galvanic isolator is provided, comprising: a data channel configured to transfer data across an isolation barrier of the multi-mode galvanic isolator; and control circuitry coupled to the data channel and configured to deactivate at least some circuitry of the data channel in response to an absence of data communication through the data channel.

According to an aspect of the present application, an isolated system is provided, comprising a first device; a second device; and a digital isolator coupling the first and second devices, wherein the digital isolator is configured to operate in a first power consumption mode when the first and second devices are communicating with each other and a second power consumption mode when the first and second devices are not communicating with each other.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 illustrates an isolated electronic system, including an isolator having multiple power modes, according to a non-limiting embodiment of the present application.

FIG. 2 is a schematic view of a digital isolator having data channels and configuration channels, according to a non-limiting embodiment of the present application.

FIG. 3 is a schematic view of an example of a digital isolator of the type shown in FIG. 2, according to a non-limiting embodiment of the present application.

FIG. 4 illustrates the digital isolator of FIG. 3, identifying the circuitry that remains active during a low power mode of operation, according to a non-limiting embodiment of the present application.

FIG. 5 is a protocol diagram illustrating a signaling sequence for waking a digital isolator from a low power mode, according to a non-limiting embodiment of the present application.

FIG. 6A is a flowchart of the operation of a first side of a digital isolator according to the protocol diagram of FIG. 5.

FIG. 6B is a flowchart of the operation of a second side of the digital isolator according to the protocol diagram of FIG. 5, complementary to the operation illustrated in FIG. 6A.

FIG. 7 is an alternative protocol diagram illustrating an alternative signaling sequence for waking a digital isolator from a low power mode, according to a non-limiting embodiment of the present application.

FIG. 8A is a flowchart of the operation of a first side of a digital isolator according to the protocol diagram of FIG. 7.

FIG. 8B is a flowchart of the operation of a second side of the digital isolator according to the protocol diagram of FIG. 7, complementary to the operation illustrated in FIG. 8A.

FIG. 9 is a protocol diagram of a keep-alive operation for a low power mode of a digital isolator, according to a non-limiting embodiment of the present application.

### DETAILED DESCRIPTION

Aspects of the present application provide digital isolators operable in multiple power modes, including a low power mode in which the digital isolator does not communicate data between external devices isolated by the digital isolator. The digital isolators are configured to provide galvanically isolated communication between two devices. In an active state, the digital isolator may communicate information between the two devices via one or more data channels. When there is no data to communicate between the two devices, the digital isolator may enter a low power mode of operation, during which the digital isolator does not communicate information between the two isolated devices. In the low power mode of operation, some of the circuitry of the digital isolator may be operated in a lower power manner or may be inactivated. For example, the digital isolator may be power-gated. Operating the circuitry in a lower power manner or inactivating (turning off) some of the circuitry saves power. The isolator may wake from the low power mode in response to a detected event or may periodically wake. Circuitry on one side of the isolator may dictate when and how the isolator wakes from a lower power mode.

According to an embodiment of the present application, circuitry of the isolator that contributes to waking the isolator from a low power mode remains active during the low power mode. In some embodiments, such circuitry includes event detection circuitry and wake-up circuitry. Other types of circuitry of the isolator may be inactivated during the low power mode of operation, thus conserving power.

Operation of the isolator in the low power mode may be asymmetric. One side of the isolator may operate as the initiator and the other as the follower, for purposes of waking the isolator. Circuitry on the initiator side may engage in greater activity to monitor and control when to wake the isolator than the circuitry on the follower side.

According to an aspect of the present application, a digital isolator may be power-gated, switching between a first, active mode of operation and a second, low power mode of operation. A switch from the active mode to the low power mode may be made upon communication ceasing between two devices interconnected by the digital isolator. A switch from the low power mode of operation to the active mode of operation may be made based on a detected event or based on a periodic wake-up routine.

According to an aspect of the present application, an isolator operating in a low power mode may engage in activity to ensure both sides of the isolator are in a valid lower power mode state and not fully powered down. When the isolator is in the low power mode, some of the isolation circuitry may be inactivated to conserve power. Some circuitry, such as event detection circuitry and wake-up circuitry, may remain active to detect when to wake the isolator. Signals may be transmitted between the sides of the isolator to ensure the wake-up circuitry is functioning. In this manner, the isolator may be kept alive without it fully waking up.

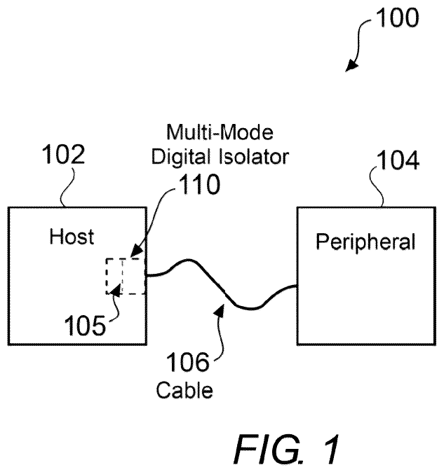

As described above, aspects of the present application provide digital isolators operable in multiple power modes, including a low power mode in which the digital isolator does not communicate data between external devices isolated by the digital isolator. In this mode, certain circuitry of the isolator may be operated in a lower power manner or may be deactivated, to conserve power. FIG. 1 illustrates a non-limiting example, showing an isolated electronic system, including an isolator having multiple power modes, according to a non-limiting embodiment of the present application. The system 100 includes a Host 102 and Peripheral 104 connected by a cable 106. A multi-mode digital isolator 110 is located within the Host 102.

The Host 102 may be any suitable host. For example, the Host 102 may be a USB Host, such as a laptop or desktop computer. Alternative types of hosts are possible.

The Peripheral 104 may be any suitable type of peripheral. For example, the peripheral may be a sensor, medical device, or piece of industrial machinery. In some embodiments, the Peripheral 104 is a USB peripheral configured to communicate with other devices via a USB protocol.

The cable 106 may be any suitable cable to handle communications between the Host 102 and Peripheral 104. For example, when the Host 102 is a USB host and the Peripheral 104 is a USB peripheral, the cable 106 may be a USB cable configured to support communications according to a USB protocol. In some embodiments, the cable 106 supports USB2.0 communication. However, other types of cables, including types other than USB cables, may be used, as not all embodiments are limited in this respect.

The multi-mode digital isolator 110 is configured to galvanically isolate the Host 102 and Peripheral 104, and has an isolation barrier 105. Although shown as being part of the Host 102, the multi-mode digital isolator 110 may alternatively be part of the Peripheral 104 or may be located somewhere between the Host 102 and Peripheral 104.

The multi-mode digital isolator 110 is configurable in different operating modes associated with different power consumption. In at least some embodiments, the multi-mode digital isolator 110 is a power-gated digital isolator. The multi-mode digital isolator 110 may operate in a first, active mode when the Host 102 and Peripheral 104 are communicating. In this mode, the circuitry of the multi-mode digital isolator 110 controlling communication of data across the isolation barrier of the isolator for transmission between the Host 102 and Peripheral 104 may be active. The multi-mode digital isolator 110 may also be operable in a second, low power mode. The low power mode is characterized by a reduced power consumption relative to the active mode of operation. The low power mode may be utilized when there is no data to transfer between the Host 102 and Peripheral 104. Some of the circuitry of the multi-mode digital isolator 110 may be inactive during the low power mode or may operate in a reduced power manner.

The power reduction in the low power mode of the digital isolator may be significant. As described above, the digital isolator may be power-gated. Turning off some of the circuitry of the digital isolator may produce significant power savings, even compared to leaving the circuitry active in a quiescent state. In some embodiments, the power reduction may be 75% or more. In some embodiments, operating the digital isolator in a low power mode, such as via power-gating, may reduce the power consumption by between 75% and 95% compared to the active mode of operation, greater than 80%, greater than 90%, greater than 99%, or any other suitable value. In some embodiments, the low power mode may draw less than 100 microAmps of current, less than 50 microAmps of current, less than 30 microAmps of current, or less than 15 microAmps of current.

In some embodiments, the power savings may be different for the two isolated sides of the digital isolator. For example, the side of the digital isolator configured to couple to a peripheral may be configured to experience a larger drop in power consumption during power-gating than the side of the digital isolator configured to couple to a host device. The side of the digital isolator configured to couple to a peripheral may be more likely to be battery powered—drawing power from a battery of a peripheral—than the side of the digital isolator configured to couple to a host. Thus, providing substantial power consumption reduction for the side of the digital isolator configured to couple to the peripheral may particularly beneficial. The power reduction experienced by that side of the digital isolator may be any of the values described above, or any other suitable value.

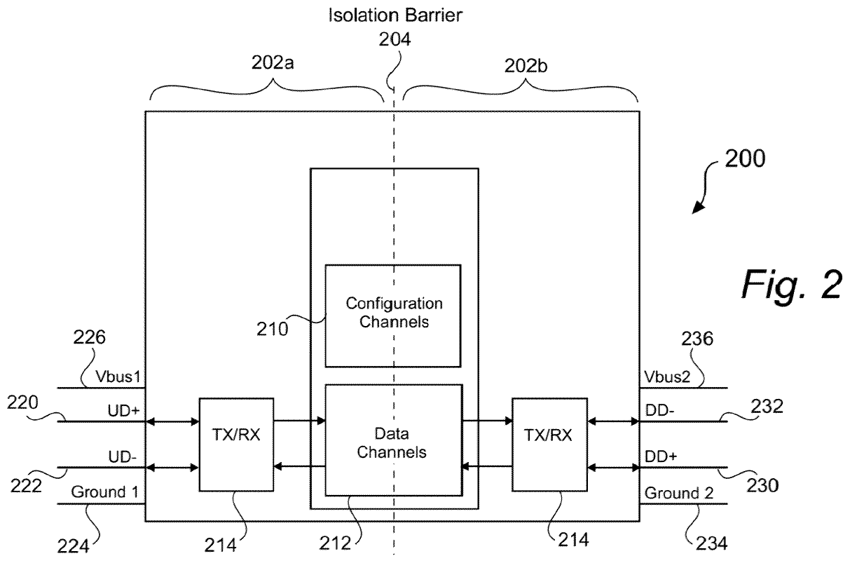

FIG. 2 is a schematic view of a digital isolator having data channels and configuration channels, and operable in multiple power modes including a low power mode, according to a non-limiting embodiment of the present application. In some embodiments, the digital isolator 200 may be a USB isolator, although alternatives are possible. The digital isolator 200 comprises voltage domains 202a and 202b galvanically isolated by an isolation barrier 204. The digital isolator 200 further comprises configuration channels 210 and data channels 212 bridging the isolation barrier 204. Transmit and receive circuitry (TX/RX) 214 is included and operates as part of the data channel communication path. The digital isolator includes several terminals or pins for communication with external devices, including terminals UD+ 220, UD− 222, Ground 1 224, Vbus1 226, DD+ 230, DD− 232, Ground 2 234, and Vbus2 236.

The voltage domains 202a and 202b may be any suitable voltage domains. In some embodiments, the voltage domains may differ in the maximum voltage they handle. For example, one of the voltage domains may be a 5V domain, and the other a 1.8V domain, although these are non-limiting examples. For instance, the voltage domains may differ in their maximum voltage handling capability by tens or even hundreds of Volts. In some embodiments, the voltage domains 202a and 202b may be referenced to different ground potentials. For example, Ground 1 and Ground 2 may differ. In some embodiments, both conditions—maximum voltage handling capability and ground reference—differ between the voltage domains 202a and 202b. The circuitry in one voltage domain may be implemented on a first semiconductor die or chip, and the circuitry in the other voltage domain may be implemented on a separate semiconductor die or chip.

The isolation barrier 204 may be realized in any suitable manner. In some embodiments, the isolation barrier 204 is realized by a dielectric material. For example, the circuitry of voltage domain 202b may be implemented on a semiconductor die, with a dielectric layer provided on top to isolate the circuitry from the circuitry of voltage domain 202a.

The configuration channels 210 communicate configuration and/or clock information across the isolation barrier 204. For example, if the digital isolator 200 is a USB isolator, the configuration channels 210 may communicate non-data USB configuration and operating states, such as the device speed mode, suspend, or other states. If clock information is to be transmitted across the isolation barrier 204, that may be done by one or more of the configuration channels 210. Alternatively, circuitry may be provided within each voltage domain 202a and 202b to handle clocking of the other circuitry in that voltage domain.

Any suitable number of configuration channels may be provided. In some embodiments, a single configuration channel may be provided. In other embodiments, multiple configuration channels may be provided.

The configuration channels 210 comprise any suitable circuitry for communicating the type of information described above. For example, each of the configuration channels 210 is an isolated channel in this non-limiting embodiment, providing isolated communication across the isolation barrier 204. Transformers, capacitors, or optical isolators may be included within the configuration channel(s) as isolation components allowing communication across the isolation barrier 204.

The data channels 212 communicate data between two isolated devices. For example, the data channels 212 may communicate data between a host and peripheral, such as those shown in FIG. 1. Thus, it should be appreciated that in some embodiments the data channels 212 may communicate USB data between two USB devices. The data channels 212 are isolated channels including any suitable circuitry for communicating the described types of data. Transformers, capacitors, or optical isolators may be included within the data channels as isolation components allowing communication across the isolation barrier 204.

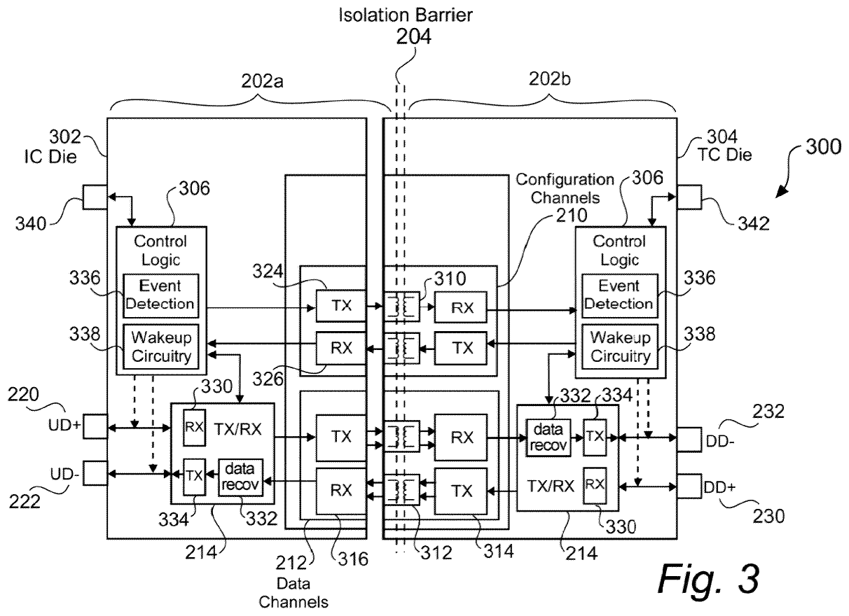

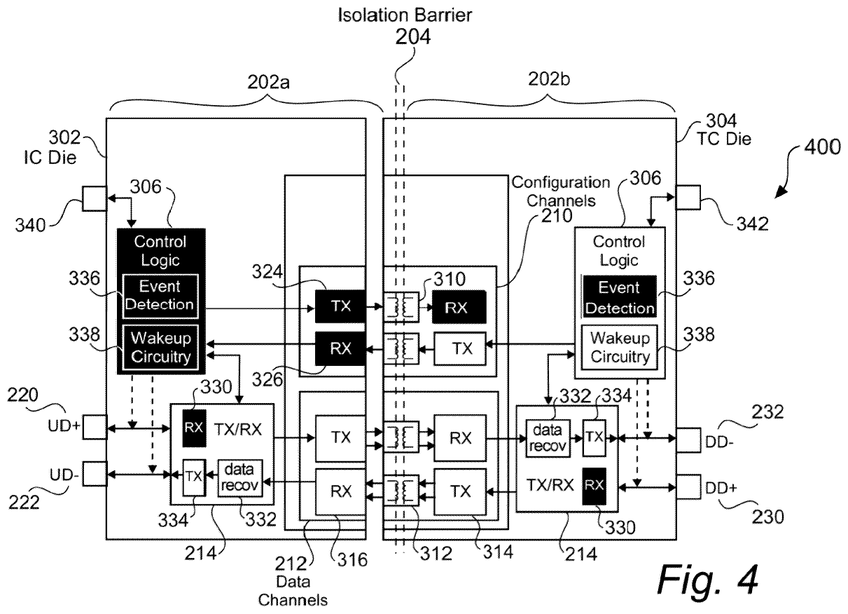

The data channels 212 may include two or more data channels, which in combination may provide bidirectional communication. In some embodiments, each of the data channels 212 is unidirectional. For example, one data channel may communicate information from UD+ and UD− to DD− and DD+, and another data channel may communicate information in the opposite direction. Non-limiting examples of the circuitry of data channels 212 are described further below in connection with FIGS. 3-4.

The data channels 212 may be configured to transmit a serial stream of two logic levels. For example, the data channels 212 may comprise circuitry configured to transmit logical 1's and 0's. In this manner, the data channels 212 may be single bit data channels, although alternative data channel structures are possible.

The transmit and receive circuitry 214 is located on both sides of the isolation barrier 204 and operates as part of the data communication. The terminals UD+ 220, UD− 222, Ground 1 224, and Vbus1 226 may be connected to a first external device (not shown), and the terminals DD+ 230, DD− 232, Ground 2 234, and Vbus2 236 may be connected to a second external device (not shown). For example, the first external device may be a USB host and the second external device may be a USB peripheral. Data is communicated between the external devices via the data channels 212. The data may travel in either direction. For example, the data may enter the digital isolator 200 on terminals UD+ 220 and UD− 222 and be conveyed out terminals DD+ 230 and DD− 232, or vice versa. The data may travel through the transmit and receive circuitry 214. Non-limiting examples of the transmit and receive circuitry 214 are also described further below.

The digital isolator 200 may couple to devices which communicate data over two wires, such as with a USB2.0 communication protocol. The data may be received on terminals UD+ 220 and UD− 222 or DD+ 230 and DD− 232. For example, an input data signal can be received at the UD+ 220 and UD− 222 terminals. The signal on each of those terminals may assume a logic 1 or logic 0 level. Other communication schemes are possible, as not all embodiments relating to a digital isolator operable in a low power mode are limited in this respect.

FIG. 3 is a schematic view of an example of a digital isolator of the type shown in FIG. 2, according to a non-limiting embodiment of the present application. Several components illustrated in FIG. 3 were previously described in connection with FIG. 2, and therefore are not described again in detail here. As shown, the digital isolator 300 is implemented on two dies, IC die 302 and TC die 304. The terms “IC” and “TC” in this context are simply labels, and other labels could be used to designate the dies. The digital isolator 300 comprises control logic 306, isolation components 310, isolation components 312, transmitters 314, receivers 316, transmitters 324, receivers 326, receivers 330, data recovery block 332, transmitters 334, event detection circuitry 336, wakeup circuitry 338, and terminals 340 and 342.

The two dies, IC die 302 and TC die 304, may be semiconductor dies or other suitable substrates. In some embodiments, the other circuitry of digital isolator 300 is integrated circuitry, and therefore the IC die 302 and TC die 304 may be suitable dies for supporting such integrated circuitry. In the non-limiting example shown, the isolation components 310 and 312, which may be any of the types of isolation components described previously in connection with FIG. 2, are formed on the TC die 304, although alternative positioning for the isolation components 310 and 312 is possible.

The control logic 306 may operate as system management logic. In some embodiments, the control logic 306 is configured to control operation of the data channels 212, configuration channels 210 and/or clocking functionality of the digital isolator 300. The control logic 306 includes any suitable circuitry for performing such functions. In the non-limiting example shown, the control logic 306 includes event detection circuitry 336 and wakeup circuitry 338. As will be described in further detail below, digital isolators of the types described herein, having a low power mode of operation, may be woken from the low power mode of operation. The digital isolator may wake in response to detection of a particular event or may wake periodically. The event detection circuitry 336 may detect events of the type that prompt the digital isolator to wake from the low power mode. The wakeup circuitry 338 may control waking of the digital isolator. For example, the wakeup circuitry 338 may control or implement one or more of the wakeup routines described further below. Communication associated with any such waking of the digital isolator may be conducted over the configuration channels 210 in some embodiments.

The digital isolator 300 further comprises transmitters 324 and receivers 326 as part of the configuration channels 210. The transmitters 324 and receivers 326 include suitable circuitry for transmitting and receiving, respectively, configuration and operating state data and/or clocking data across the isolation barrier.

The digital isolator 300 further comprises transmitters 314 and receivers 316 as part of the data channels 212. The transmitters 314 and receivers 316 are configured to transmit and receive, respectively, data across the isolation barrier 204. For example, data to be communicated between two isolated devices, such as the host and peripheral of FIG. 1, may be transmitted across the isolation components 312 of the data channels 212 using the transmitters 314 and receivers 316.

The transmit and receive circuitry 214 comprises receivers 330, data recovery block 332, and transmitters 334. The receivers 330 are configured to receive data coming into the digital isolator 300. For example, data coming into terminals UD+ 220 and UD− 222 is received by the receiver 330 in the voltage domain 202a, and data coming in to terminals DD− 232 and DD+ 230 is received by the receiver 330 in the voltage domain 202b. The receivers 330 may filter, amplify, or otherwise process the received data before passing it along the data channels 212. The data recovery block 332 may be included in the transmit and receive circuitry 214 if the communication across the isolation components 312 is coded. For example, if the data received by receivers 330 is coded before transmission across the isolation barrier 204, then data recovery block 332 may be used to recover the encoded data, by decoding such data. Data recovery block is optional, as some embodiments do not entail encoding of data for communication across the isolation barrier 204. The transmitters 334 receive data communication across the isolation components 312 and transmit the data out of the digital isolator 300 on the terminals UD+ 220 and UD− 222 and/or terminals DD− 232 and DD+ 230.

The terminals 340 and 342 are provided for connection to control logic 306 in the voltage domains 202a and 202b. Terminals 340 and 342 may be coupled to any suitable external devices for communication of configuration and operating state information.

As described above, aspects of the present application provide a digital isolator configured to operate in an active mode and a low power mode. The digital isolator 300 is a non-limiting example of one such isolator. All, or substantially all, of the circuitry of the digital isolator 300 shown in FIG. 3 may be active when data is being communicated over the data channels 212. In such an active state, communication may occur across one or more of the data channels 212 and one or more of the configuration channels 210. The data communication may occur at various speeds. For example, when the digital isolator 300 is a USB 2.0 isolator, data communication during the active mode of operation may occur at low (e.g., 1.5 Mbps), full (e.g., 12 Mbps), or high (e.g., 480 Mbps) speeds. Irrespective of the speed, the digital isolator is active in that data communication along one or more of the data channels 212 is occurring. By contrast, when the digital isolator 300 is not communicating data along the data channels 212, it may enter a low power mode. The low power mode is characterized by lower power consumption than during the active mode, and by the lack of communication over the data channels 212. In this mode, some of the circuitry of the digital isolator may be deactivated or may operate in a manner in which less power is consumed than when operating in the active mode.

FIG. 4 illustrates the digital isolator 300 of FIG. 3, identifying the circuitry that remains active during a low power mode of operation, according to a non-limiting embodiment of the present application. Specifically, in this non-limiting example, the circuitry that remains active during the low power mode of operation is shaded in black. The remaining circuitry is inactive in this mode.

The circuitry which remains active during the low power mode of operation is circuitry which play a role in waking the digital isolator from the low power mode. The control logic 306, and in particular the event detection circuitry 336 and wakeup circuitry 338 may remain active to ensure detection of an event prompting the digital isolator 300 to wake from the low power mode. Since the event prompting the digital isolator to wake may be an external event, such as receipt of data from a host or peripheral device coupled to the digital isolator, the receiver 330 is active. In this manner, the receiver 330 can communicate signals associated with such an event to the event detection circuitry 314. One or more transmitters 324 and one or more receivers 326 may remain active to communicate wakeup information across one or more configuration channels 210.

The power savings from the low power mode of digital isolators of the types described herein may be significant. Referring still to FIG. 4, it can be seen that substantial circuitry may be inactive during the low power mode of operation. For example, control logic in one voltage domain, transmitters and receivers within that voltage domain, and the circuitry of the data channels for the most part (other than the receivers 330) may be inactive. As a result, the digital isolator may consume significantly less power in the lower power mode than in the active mode.

As has been described previously, in the low power mode of operation of the digital isolator, there may be no communication across the data channels 212. For instance, there may be a pause in communication between a host and peripheral device of the types illustrated in FIG. 1. Thus, maintaining the isolator in an active state during that time leads to unnecessary power consumption. Since no data communication is occurring between the isolated devices, the isolator can transparently enter the low power mode. When the isolated devices begin communication again, the isolator can wake, resuming its active state and permitting data communication over the data channels 212.

A digital isolator configurable to operate in an active mode and a low power mode may enter the low power mode for various reasons. In some embodiments, the isolator may enter the low power mode when there is no data communication coming into the isolator. For example, if the data bus feeding the isolator is suspended, the isolator may enter a low power mode. In some such embodiments, the isolator may enter the low power mode when the bus is suspended for a duration greater than a threshold, such as 5 msec, 3 msec, or any other suitable duration. In some embodiments, the isolator may enter the low power mode when no external device is connected to a downstream side of the isolator. For example, if no external device is connected to the DD+ 230 and DD− 232 terminals, the low power mode may be entered. Another reason for entering the low power mode is if there is a loss of communication from the other side of the isolator. For example, if one voltage domain of the isolator loses communication with the other voltage domain, the low power mode may be entered. In some embodiments, the low power mode may be entered when data communication between two devices separated by isolator ceases. In some embodiments, the low power mode may be entered if the power supply on one or both sides of the isolator is too low. Any of the foregoing reasons or any combination of such reasons may prompt the isolator the enter the low power mode. Circuitry not needed to wake the digital isolator may be inactivated or operated in a reduced power manner.

Digital isolators of the types described herein may wake from a low power mode in various ways. In some embodiments, the digital isolator may periodically wake from the low power mode. Upon waking, the digital isolator may check for activity, such as incoming data from an external device. If a particular type of activity is detected, the digital isolator may undertake a wakeup routine. If no activity is detected, the digital isolator may re-enter the low power mode. In an alternative embodiment, the digital isolator may wake upon detection of a particular event, rather than waking periodically. The event may be the receipt of data from an external device. For example, the detection of data on the UD+ 220 and UD− 222 terminals or DD+ 230 and DD− 232 terminals may trigger exiting the low power mode. The event may be detected by event detection circuitry of the digital isolator, prompting execution of a wakeup routine. Non-limiting examples of methods of waking a digital isolator from a low power mode are described now.

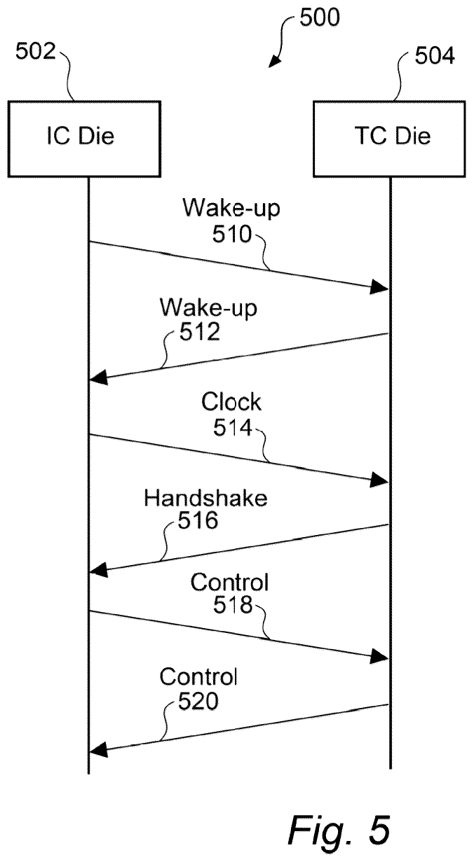

FIG. 5 is a protocol diagram illustrating a signaling sequence for waking up a digital isolator from a low power mode, according to a non-limiting embodiment of the present application. In this non-limiting embodiment, the digital isolator has two dies, including an IC die 502 and TC die 504. The IC die 502 and TC die 504 may be of the same types as described previously for IC die 302 and TC die 304, respectively. In this example, it is assumed that the IC die 502 operates as the initiator die for purposes of waking the isolator. That is, the IC die 502 is responsible for waking the digital isolator from the low power mode, either by detecting an event or by periodically waking the isolator.

The illustrated protocol 500 begins with the IC die 502 sending a wake-up signal 510 to the TC die 504. The wake-up signal may be any suitable wake-up signal. For example, a pulse sequence may be transmitted from control logic on the IC die to control logic of the TC die.

In response, the TC die 504 sends a wake-up signal 512 to the IC die 502. The wake-up signal 512 lets the IC die 502 know that the TC die 504 received the wake-up signal 510. To send the wake-up signal 512, the TC die 504 may power up and confirm that its power supply is valid. Then it may send the wake-up signal 512, which may be considered a wake-up response.

The next step of the protocol 500 assumes that clock signals are provided by the IC die 502 to the TC die 504. As described previously, in some embodiments the configuration channels of a digital isolator may be used to send clock signals between the voltage domains. After the wake-up signals of FIG. 5 are sent, the IC die 502 and TC die 504 power-up their clocking circuitry. In this non-limiting example, the IC die 502 may achieve valid, steady-state operation of its clock signal (e.g., locking of a phase-locked loop (PLL) when a PLL is included), and then send a clock signal 514 to the TC die 504. The TC die 504 may receive the clock signal and synchronize to it. In an alternative embodiment in which the IC die 502 and TC die 504 do not exchange clock signals, then the transmission of clock signal 514 may be omitted, and the two die may simply power-up their respective clock circuitry.

Continuing with FIG. 5, the TC die 504 may then send a handshake signal 516.

After that, the IC die 502 and TC die 504 begin active operation in the form of exchanging configuration or status information. For example, the IC die 502 may send control signal 518 to the TC die 504, and the TC die 504 may send control signals 520 to the IC die 502.

If at any point during the operation of FIG. 5 the IC does not receive a valid response from the TC die, the process may be aborted and the digital isolator may return to a lower power mode.

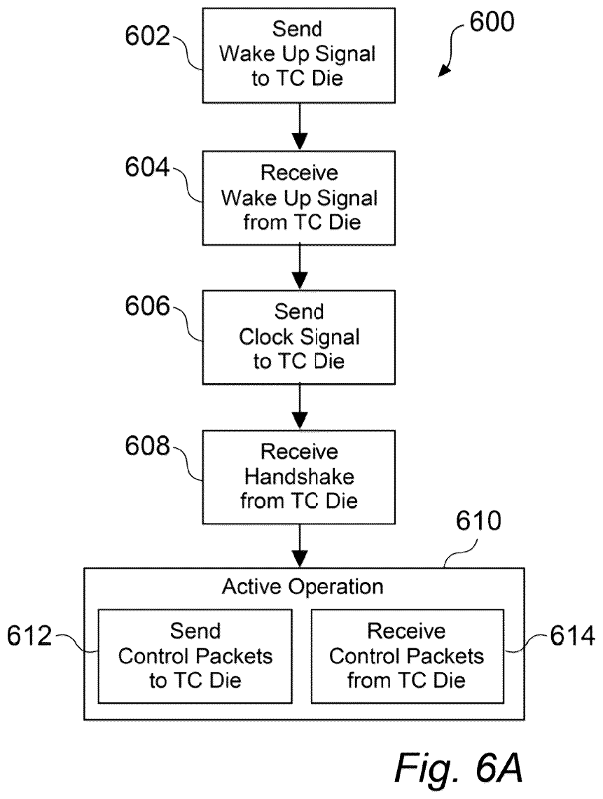

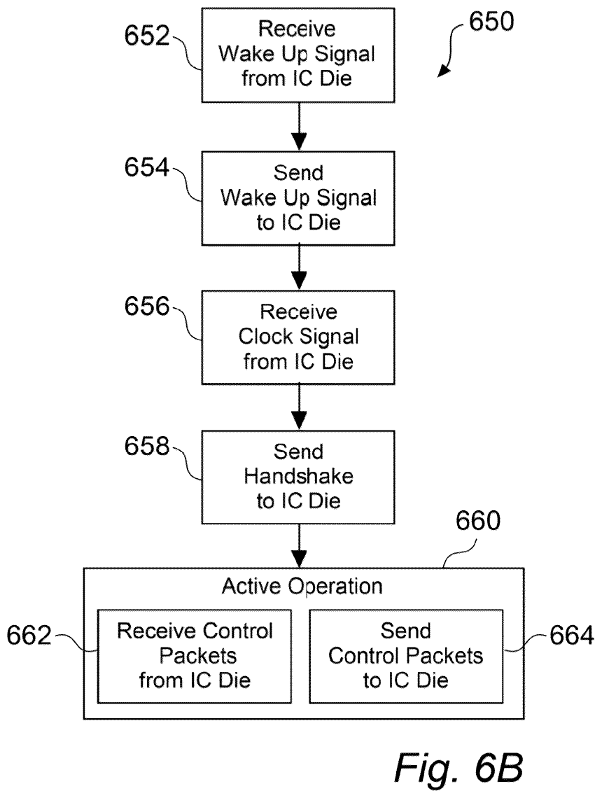

FIG. 6A is a flowchart of the operation of a first side of a digital isolator according to the protocol diagram of FIG. 5. For example, the method 600 of FIG. 6A illustrates what may be the operation of IC die 502 according to the protocol 500 of FIG. 5, when the IC die is the initiator for wakeup signaling. At stage 602, the IC die 502 sends a wake-up signal (e.g., wake-up signal 510) to the TC die 504. The IC die 502 then receives a wake-up signal (e.g., wake-up signal 512) from the TC die 504. The IC die 502 then sends a clock signal (e.g., clock signal 514) to the TC die 504. The IC die 502 then receives a handshake signal (e.g., handshake signal 516) from the TC die 504. The IC die 502 then enters active operation, involving sending control data packets to the TC die at stage 612 and receiving control packets from the TC die at stage 614. In some embodiments, the control data packets are packets of USB state information and thus may be considered state information packets. Not all embodiments are limited in this respect, however.

FIG. 6B is a flowchart of the operation of a second side of the digital isolator according to the protocol diagram of FIG. 5, complementary to the operation illustrated in FIG. 6A. For example, FIG. 6B may represent the operation of the TC die 504 in the protocol 500 of FIG. 5, when the TC die is the follower for wakeup signaling. The process 650 begins at stage 652, with the TC die 504 receiving the wake-up signal (e.g., wake-up signal 510) from the IC die 502. At stage 654 the TC die 504 sends a wake-up signal (e.g., wake-up signal 512) to the IC die 502. At stage 656, the TC die 504 receives a clock signal (e.g., clock signal 514) from the IC die 502. At stage 658 the TC die 504 sends a handshake signal (e.g., handshake signal 516) to the IC die 502. At stage 660 the TC die assumes active operation, including receiving control packets from the IC die at stage 662 and sending control packets to the IC die at stage 664.

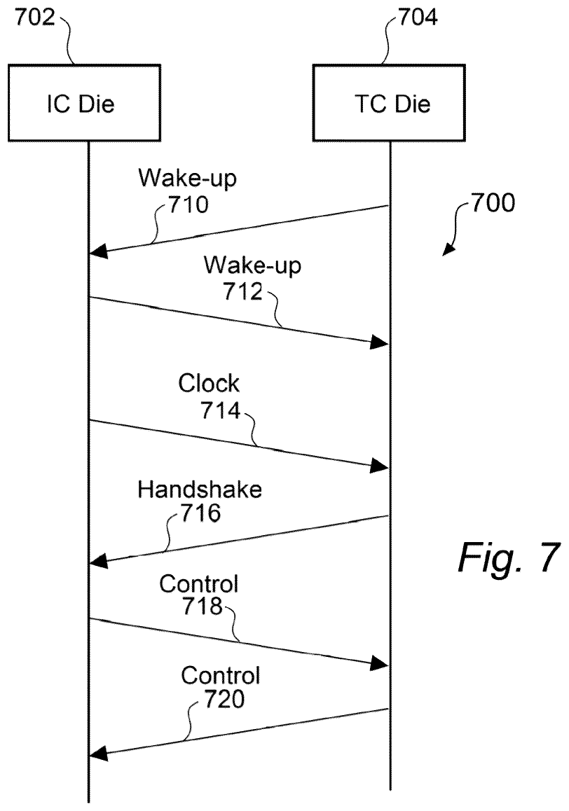

FIG. 7 is an alternative protocol diagram illustrating an alternative signaling sequence for waking up a digital isolator from a low power mode, according to a non-limiting embodiment of the present application. For purposes of this example, it is assumed that the TC die operates as the initiator, being responsible for the wake-up routine. The protocol begins with the TC die 704 sending a wake-up signal 710 to the IC die 702. In response, the IC die 702 powers up and sends a responsive wake-up signal 712.

In this non-limiting example, as with the protocol of FIG. 5, it is assumed that clock signals are sent between the two dies. Thus, as shown, the IC die 702 sends a clock signal 714 to the TC die 704. This transmission may be omitted in embodiments in which the IC die and TC die have their own clocking circuitry and do not exchange clock signals.

Next, the TC die 704 sends a handshake signal 716 to the IC die 702. Upon receiving the handshake signal 716, the IC die 702 enters active operation and proceeds to send a control signal 718 to the TC die 704. The TC die 704 may send a control signal 720 to the IC die 702.

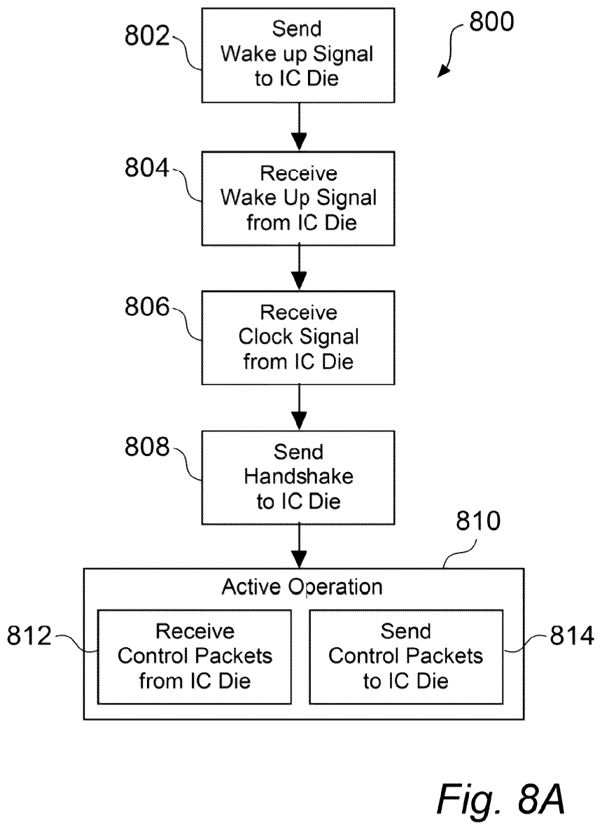

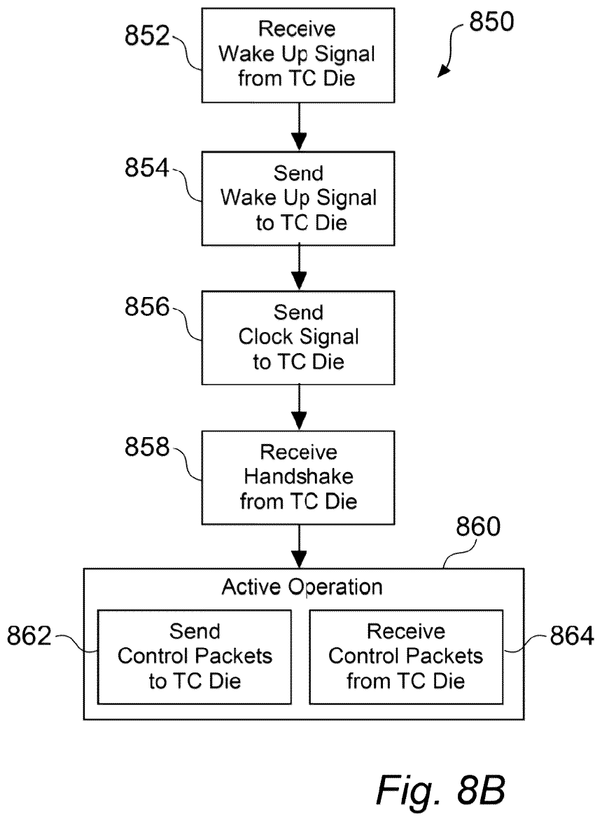

FIG. 8A is a flowchart of the operation of a first side of a digital isolator according to the protocol diagram of FIG. 7. For example, the method 800 of FIG. 8A may represent the operation of TC die 704, when the TC die is the initiator for wakeup signaling. At stage 802, the TC die sends a wake-up signal (e.g., wake-up signal 710) to the IC die. At stage 804, the TC die receives a wake-up signal (e.g., wake-up signal 712) from the IC die. At stage 806, the TC die receives a clock signal (e.g., clock signal 714) from the IC die. At stage 808, the TC die sends a handshake signal (e.g., handshake signal 716) to the IC die. The TC die then enters active operation, during which it may receive control packets from the IC die at stage 812 and send control packets to the IC die at stage 814.

FIG. 8B is a flowchart of the operation of a second side of the digital isolator according to the protocol diagram of FIG. 7, complementary to the operation illustrated in FIG. 8A. For example, the method 850 of FIG. 8B may represent the operation of IC die 702 in FIG. 7, when the IC die is the follower for wakeup signaling. At stage 852, the IC die receives a wake-up signal (e.g., wake-up signal 710) from the TC die. At stage 854, the IC die sends a wake-up signal (e.g., wake-up signal 712) to the TC die. At stage 856, the IC die sends a clock signal (e.g., clock signal 714) to the TC die. At stage 858 the IC die receives a handshake signal (e.g., handshake signal 716) from the TC die. At stage 860 the IC die enters active operation, during which it may send control packets to the TC die at stage 862 and receive control packets from the TC die at stage 864.

FIGS. 5 and 7 illustrate examples in which the IC die sends clock signals to the TC die. In alternative embodiments, clock signals may instead be sent by the TC die to the IC die. Thus, FIGS. 5 and 7 are non-limiting examples.

As described above, aspects of the present application are directed to a digital isolator with a low power mode and keep-alive functionality to maintain the isolator circuitry in the low power mode. The keep-alive function may be used to inform circuitry in one voltage domain of the isolator that the power supply in the other voltage domain of the isolator is valid. According to one embodiment, the keep-alive functionality may utilize a wake-up signal of the types previously described as being sent between an IC die and TC die, with a difference provided for keeping the circuitry alive but in low power mode as opposed to waking the circuitry. The difference may be duration of the wake-up signal in some embodiments. For example, a wake-up signal of a duration below a threshold may be treated by the receiving side of the isolator as a signal merely keeping the isolator alive, but not initiating a wakeup routine. By contrast, a wake-up signal with a duration greater than the threshold may be treated as a signal initiating a wake-up routine of the types described previously herein.

The wake-up routines illustrated with respect to FIGS. 5-8B may be event driven or periodic. For example, the wake-up signals 510 and 710 in FIGS. 5 and 7 may be prompted by detection of an event, or may be sent as part of a periodic transmission of wake-up signals when a digital isolator is in a low power mode. Event-driven wake-up may exhibit low latency and thus be desirable in applications with strict timing requirements. Periodic wake-up routines may provide a fallback mechanism or may be desirable in applications without strict timing requirements. Other scenarios are also possible for choosing between event-driven and periodic wake-up routines.

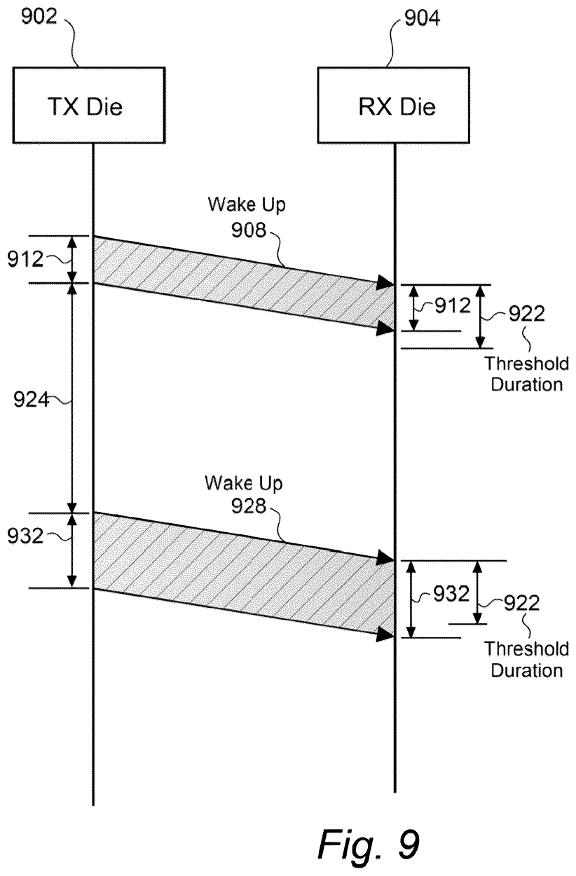

FIG. 9 is a protocol diagram of a keep-alive operation for a low power mode of a digital isolator, according to a non-limiting embodiment of the present application. In this non-limiting example, the two dies shown are labeled as TX die 902 and RX die 904. Either may be an IC die and the other a TC die.

The TX die 902 sends a first wake-up signal 908. This wake-up signal has a duration 912, represented by the extent of the shaded region in the vertical direction of the figure. The wake-up signal 908 is received at the RX die 904 and the duration 912 is compared to a threshold duration 922. The threshold duration 922 may be set by a fixed time, such as a one-shot circuit, a watchdog timer, or any other suitable circuit. In this situation, the duration 912 is less than the threshold duration 922. The RX die 904 therefore does not interpret the wake-up signal 908 as an indication to engage in a wake-up routine. Instead, the TX die 902 and RX die 904 return to the low power mode, for example for the period 924. However, the RX die 904 does interpret the wake-up signal 908 having a duration 912 less than the threshold duration 922 as an indication that the power supply on the TX die 902 is valid.

At a later time, the TX die 902 sends wake-up signal 928, having a duration 932 represented by the extent of the shaded region in the vertical direction of the figure. The RX die 904 receives the wake-up signal 928 and compares the duration 932 to the threshold duration 922. Since the duration 932 is greater than the threshold duration 922, the RX die 904 interprets the wake-up signal 928 as an indication to wake. For example, the wake-up signal 928 may be treated as wake-up signal 510 or wake-up signal 710 of FIGS. 5 and 7, respectively. One of the previously described wake-up routines may then be undertaken, or any other suitable wake-up routine may be implemented.

Having thus described several aspects of at least one embodiment, it is to be appreciated that various alterations, modifications, and improvements will readily occur to those skilled in the art. As one example, different features were discussed above in connection with different embodiments. Those features may be used alone or in combination unless otherwise noted.

1. A method of operating a digital isolator having an isolation barrier, an isolated data channel and an isolated configuration channel, the method comprising:
operating the digital isolator in a first mode in which data is communicated across the isolation barrier on the data channel and configuration information is communicated across the isolation barrier on the configuration channel; and
operating the digital isolator in a second mode in which the data channel is inactive.

2. The method of claim 1, further comprising entering the second mode in response to detecting a lack of communication on the data channel.

3. The method of claim 1, further comprising, when operating the digital isolator in the second mode, conveying a wake-up signal across the isolation barrier.

4. The method of claim 3, wherein conveying the wake-up signal across the isolation barrier comprises conveying the wake-up signal as part of a periodic transmission of wake-up signals across the isolation barrier.

5. The method of claim 3, wherein conveying the wake-up signal across the isolation barrier comprises conveying the wake-up signal in response to detecting an event.

6. The method of claim 1, wherein operating the digital isolator in the second mode comprises reducing a power consumption of the digital isolator relative to the first mode by at least 70% by deactivating circuitry of the digital isolator.

7. The method of claim 1, wherein operating the digital isolator in the second mode comprises reducing a power consumption of a first side of the digital isolator by at least 70%.

8. The method of claim 7, further comprising drawing current from an external battery coupled to the first side of the digital isolator.

9. The method of claim 1, further comprising, when operating the digital isolator in the second mode, periodically performing a keep-alive operation by conveying a signal indicating a power condition across the isolation barrier.

10. A multi-mode galvanic isolator, comprising:
a data channel configured to transfer data across an isolation barrier of the multi-mode galvanic isolator; and
control circuitry coupled to the data channel and configured to deactivate at least some circuitry of the data channel in response to an absence of data communication through the data channel.

11. The multi-mode galvanic isolator of claim 10, wherein the control circuitry is configured to activate the at least some circuitry of the data channel after deactivating the at least some circuitry.

12. The multi-mode galvanic isolator of claim 10, further comprising wakeup circuitry configured to transfer a wakeup signal across the isolation barrier when the at least some circuitry of the data channel is deactivated.

13. The multi-mode galvanic isolator of claim 10, wherein the multi-mode galvanic isolator is configured to consume at least 70% less power when the at least some circuitry is deactivated.

14. The multi-mode galvanic isolator of claim 13, wherein a first side of the multi-mode galvanic isolator is configured to consume at least 80% less power when the at least some circuitry is deactivated.

15. The multi-mode galvanic isolator of claim 10, wherein the control circuitry comprises event detection circuitry configured to detect a data transmission event.

16. An isolated system, comprising
a first device;
a second device; and
a digital isolator coupling the first and second devices, wherein the digital isolator is configured to operate in a first power consumption mode when the first and second devices are communicating with each other and a second power consumption mode when the first and second devices are not communicating with each other.

17. The isolated system of claim 16, wherein the second power consumption mode consumes at least 70% less power than the first power consumption mode.

18. The isolated system of claim 17, wherein a first side of the digital isolator is configured to consume at least 80% less power in the second power consumption mode than in the first power consumption mode.

19. The isolated system of claim 16, wherein the digital isolator is configured to deactivate a portion of its circuitry during the second power consumption mode.

20. The isolated system of claim 19, wherein the digital isolator comprises wakeup circuitry configured to be active during the second power consumption mode.
